(19) United States
(12) Patent Application Publication
(10) Pub. No.: US 2008/0041713 A1
(43) Pub. Date: Feb. 21, 2008

(54) METHOD AND APPARATUS FOR THE VARIABLE EXTRACTION OF A PRESSURIZED PRODUCT BY LOW-TEMPERATURE GAS FRACTIONATION

(75) Inventors: Ulrich EWERT, Bichl (DE); Alfred Wanner, Deisenhofen (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Wiesbaden (DE)

(21) Appl. No.: 11/839,389

(22) Filed: Aug. 15, 2007

(30) Foreign Application Priority Data
Aug. 16, 2006 (EP) 06017089.1

(51) Int. Cl. B01D 3/42; G05D 7/00

(52) U.S. Cl. 203/2; 202/160; 700/281

(57) ABSTRACT

A method and apparatus for the variable extraction of a pressurized product by low-temperature gas fractionation in a distillation column system, is disclosed. Feed gas is cooled and taken to the distillation column system. A product stream is removed from the distillation column system. The product stream is brought to a high pressure in a liquid state. The product stream is evaporated or pseudo-evaporated at the high pressure through indirect heat exchange with a heat carrier stream. The heat carrier stream is at least partially condensed or pseudo-condensed in the indirect heat exchange. The evaporated, or pseudo-evaporated, product stream is removed in variable quantity as pressurized product. The quantity of heat transferred in the indirect heat exchange is balanced. From this balance, a target value for the volume of at least one of the streams involved in the indirect heat exchange is calculated. This target value is adjusted as part of forward feed control.

This application claims the priority of European Patent Application No. 06017089.1, filed Aug. 16, 2006, the disclosure of which is expressly incorporated by reference herein.

### BACKGROUND AND SUMMARY OF THE INVENTION

The invention relates to a method for extracting a compressed product by low-temperature gas fractionation, specifically low-temperature air fractionation by means of internal compression.

Methods and apparatuses for gas fractionation, specifically for low-temperature fractionation of air are known, for example, from Hausen/Linde, Low-temperature technology, 2nd edition 1985, Chapter 4 (pages 281 to 337). A “distillation column system” comprises at least one separation column and the condensers and evaporators assigned to the separation columns of the system. The distillation column system of the invention can be configured as a single-column system for nitrogen-oxygen separation, as a two-column system (for example as a classic Linde double-column system), or a three or more column system. In addition to the columns for nitrogen-oxygen separation, it may have further apparatuses for the extraction of other air components, specifically noble gases, for example, argon extraction.

With an internal compression process, at least one of the products is taken as a liquid from one of the columns of the distillation column system or from a condenser connected to one of the columns, raised to an elevated pressure in the liquid state, evaporated or (at supercritical pressure) pseudo-evaporated in indirect heat exchange with a heat carrier stream, for example with process air or nitrogen, and finally extracted as a gaseous compressed product and taken to a discharge system. The pressure increase in the liquid can be carried out using any known measure. Pumps are regularly used. However, the exploitation of a hydrostatic potential and/or the pressure buildup evaporation at a tank is also possible. The heat carrier stream condenses or (at supercritical pressure) pseudo-condenses in the indirect heat exchange.

Such internal compression methods are known, for example, from DE 830805, DE 901542 (=U.S. Pat. No. 2,712,738/U.S. Pat. No. 2,784,572), DE 952908, DE 1103363 (=U.S. Pat. No. 3,083,544), DE 1112997 (=U.S. Pat. No. 3,214,925), DE 1124529, DE 1117616 (=U.S. Pat. No. 3,280,574), DE 1226616 (=U.S. Pat. No. 3,216,206), DE 1229561 (=U.S. Pat. No. 3,222,878), DE 1199293, DE 1187248 (=U.S. Pat. No. 3,371,496), DE 1235347, DE 1258882 (=U.S. Pat. No. 3,426,543), DE 1263037 (=U.S. Pat. No. 3,401,531), DE 1501722 (=U.S. Pat. No. 3,416,323), DE 1501723 (=U.S. Pat. No. 3,500,651), DE 2535132 (=U.S. Pat. No. 4,279,631), DE 2646690, EP 93448 B1(=U.S. Pat. No. 4,555,256), EP 384483 B1 (=U.S. Pat. No. 5,036,672), EP 505812 B1 (=U.S. Pat. No. 5,263,328), EP 716280 B1 (=U.S. Pat. No. 5,644,934), EP 842385 B1 (=U.S. Pat. No. 5,953,937), EP 758733 B1 (=U.S. Pat. No. 5,845,517), EP 895045 B1 (=U.S. Pat. No. 6,038,885), DE 19803437 A1, EP 949471 B1 (=U.S. Pat. No. 6,185,960 B1), EP 955509 A1 (=U.S. Pat. No. 6,196,022 B1), EP 1031804 A1 (=U.S. Pat. No. 6,314,755), DE 19909744 A1, EP 1067345 A1 (=U.S. Pat. No. 6,336,345), EP 1074805 A1 (=U.S. Pat. No. 6,332,337), DE 19954593 A1, EP 1134525 A1 (=U.S. Pat. No. 6,477,860), DE 10013073 A1, EP 1139046 A1, EP 1146301 A1, EP 1150082 A1, EP 1213552 A1, DE 10115258 A1, EP 1284404 A1 (=US 2003051504 A1), EP 1308680 A1 (=U.S. Pat. No. 6,612,129 B2), DE 10213212 A1, DE 10213211 A1, EP 1357342 A1 or DE 10238282 A1, DE 10302389 A1, DE 10334559 A1, DE 10334560 A1, DE 10332863 A1, EP 1544559, EP 1585926 A1, DE 102005029274 A1, EP 1666824 A1 or EP 1672301 A1.

The heat exchangers of internal compress installations are exposed to special demands which are caused by the phase changes in the internal compression stream(s) occurring in the indirect heat exchange. Rapid changes in the internal compression streams or in the heat carrier stream serving to heat or evaporate the internal compression streams can lead to high loads on the heat exchangers and mechanically overload them.

Until now the heat exchangers have been protected by relatively simple shut down logic systems which, for example in the event of a failure of internal compression pumps or failure of the most important heat carrier stream, shuts down the installation or transfers it to a safe condition.

This method of proceeding has disadvantages since complex installation configurations make it difficult to detect the relevant malfunctions using binary conditions. Shutting down the installation as previously practiced leads to additional changes in volume and thereby stresses the heat exchanger, which should be avoided if possible.

The object of the invention is therefore to cite a method of the type named at the beginning and a corresponding apparatus which results in relatively little load on the heat exchangers for the indirect heat exchange between a (pseudo) evaporating product stream or product streams and heat carrier stream or heat carrier streams.

This object is achieved by
balancing the quantity of heat transferred in the indirect heat exchange,
calculating a target value from this balance for the volume of at least one of the streams involved in the indirect heat exchange, and
adjusting this target value as part of feed forward control.

In accordance with the invention, the heat carrier streams are controlled such that changes in volume in the internal compression stream(s) are compensated for as quickly as possible. There is a shutdown only if a great disparity arises between the internal compression streams and the heat carrier streams. Primarily the changes in volume of the internal compression and the heat carrier streams are relevant.

In the invention the ratio between the internal compression and heat carrier streams is calculated and the results of this balance calculation are used as criteria for regulating and shutting down. The measured quantities and parameters for the different heat capacities of the streams go into the balance calculation. The pressures and temperatures measured of the heat exchanger streams can optionally be considered in the balance calculation. With respect to the reliability of the balance calculation, it can be advantageous in practice to keep the number of measurements going into the balance calculation as small as possible and to ignore unimportant variables. This applies, for example, to the pressures and temperatures which are frequently approximately constant in the operating cases under consideration.

The ratio of the internal compression and heat carrier streams can be matched to volume changes in one or more streams. Normally, the free parameter with which the ratio of the internal compression and heat carrier streams can be matched is the heat carrier stream which generally comes from a booster compressor. The result of the balance calculation is consequently the required volume of the heat carrier stream with which the ratio between heat carrier and internal compression streams is matched. This result is transmitted directly as a target value to the volume regulator of the heat carrier stream as part of feed forward control.

Feed forward control represents a calculation algorithm connected to an adjuster which, similar to a control loop, serves to affect process values. In contrast to a control loop, the values set in feed forward control at the adjuster through the calculation algorithm do not have a return effect on the initial values or parameters of the calculation algorithm.

Since the balance calculation will in practice always be slightly inaccurate, it is worthwhile correcting the results of the balance calculation using measured criteria. In accordance with a further embodiment of the invention, the temperature difference between the heat carrier stream and the product stream is measured at the indirect heat exchange and the value measured for this temperature difference is considered in the calculation of the target value.

If there is an inaccuracy in the calculated target value for the expansion stream, this will be detected from the temperature differences between incoming and outgoing streams at the warm end of the heat exchanger. The required correction parameter is calculated at the output of a temperature difference controller which regulates the temperature difference between the primary heat carrier stream and the largest internal compression stream. The correct parameter works best multiplicatively on the target value of the expansion stream.

It is further advantageous if the volume of at least one of the streams involved in the indirect heat exchange is measured, the measured volume compared with the calculated target value and as a function of the difference between measured volume and target value shutting down the indirect heat exchange is initiated. Measuring the volume and target value refer to the same physical value, preferably the volume of the heat carrier stream.

If a great discrepancy arises between the calculated and measured volume of the heat carrier stream and if this ratio cannot be balanced within a tolerable period, there must be a shutdown to protect the heat exchanger and move the process to a safe condition. Parameters for the shutdown are the maximum tolerable discrepancy and the maximum tolerable time period, where both parameters affect each other, for example, a minor discrepancy can be tolerated for a longer period. To take account of the latter, it is possible to use the integral of the discrepancy over time as the shutdown criterion, which can be imaged by a dynamic first order filter (PT1) with sufficient accuracy.

Since short-term malfunctions can occur in the volume measurements going into the balance calculation, it is worthwhile filtering the volume measurements appropriately.

The method in accordance with the invention offers reliable protection for the heat exchangers of air and gas fractionation installations with internally compressed product streams. The protection works directly and with all malfunction scenarios. The system reacts very quickly to malfunctions through feed forward control of the volume of at least one heat exchanger. Shutdowns can be avoided, which has an overall positive effect on the expected life of the plant, in particular of heat exchangers, machines and other components. If the controls are not able to match the required volume ratios, a reliable shutdown criterion is still available which, with proper configuration of the controls, shuts down the installation at different speeds depending on the size of the discrepancy.

The method can be used fundamentally on any heat exchanger, on one or several heat exchangers without internal compression or without (pseudo) evaporation. It is advantageous certainly everywhere a phase transition inside the heat exchanger can cause potentially high material stresses.

The invention and additional details of the invention are explained in more detail in what follows using an embodiment shown schematically in the drawing.

### BRIEF DESCRIPTION OF THE DRAWING

FIG. 1 illustrates an air fractionation installation with generation of gaseous oxygen as pressurized product in accordance with the principles of the present invention.

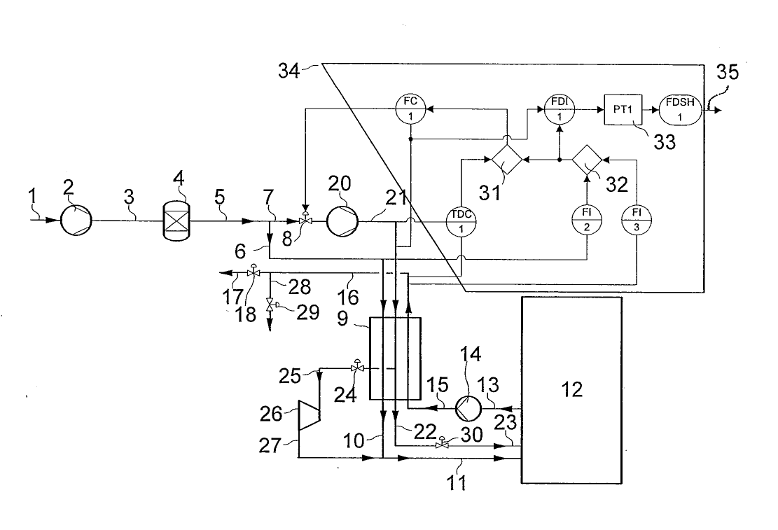

### DETAILED DESCRIPTION OF THE DRAWING

The exemplary embodiment refers to an air fractionation installation with generation of gaseous oxygen as pressurized product.

Air 1 is brought to a first pressure P1 in a primary air compressor. The compressed air 3 is purified in a purification device 4. The purified air 5 is branched into a first partial stream 6 and a second partial stream 7. The first partial stream of air 6 is cooled to about dew point in a main heat exchanger 9 and flows via the lines 10 and 11 into the distillation column system which in the embodiment has a high-pressure column and a low-pressure column which are linked in a heat exchange relationship through a common condenser-evaporator, the main condenser (not shown in the drawing). The air 11 is introduced into the high-pressure column in a practically completely gaseous state.

In the distillation column system for nitrogen-oxygen separation 12, the air is fractionated into a least one oxygen-enriched product stream 13 and at least one nitrogen-enriched fraction (not shown). The product stream 13 has, for example, an oxygen content of 98 to 99.5% mol. It is removed as a liquid, for example from the sump of the low-pressure column or the evaporation chamber of the main condenser. The liquid product stream 13 is brought to an elevated pressure PIV in a pump 14 which is higher than the operating pressure of the distillation column from which it was taken and is, for example, 15 to 30 bar. The oxygen 15 is taken at the increased pressure in liquid or supercritical condition to the cold end of the main heat exchanger 9 and evaporated in the main heat exchanger or pseudo-evaporated and heated to approximately ambient temperature. The product stream leaves the plant through an exit valve 18 as a gaseous pressurized product 16, 17 and is taken to one or more consumers. Alternatively, or in addition, non-usable product is vented to atmosphere through line 28 and the valve 29.

A heat carrier stream 21, which is also called internal compression air and represents a part of the second partial air stream 7, provides the heat needed for the (pseudo) evaporation; this second air stream is recompressed in a compressor 20 to a high pressure PW which is higher than the first pressure P1 and, for example, is 30 to 40 bar. This pressure in the partial stream 21/22 is adjusted through the valve 8 or the blades of the compressor 20. The internal compression air 22 flows through the main heat exchanger 9 at this high pressure to the cold end and is condensed in indirect heat exchange with the (pseudo) evaporating oxygen 15 or—at supercritical pressure—pseudo-condensed. The internal compression air is expanded through a valve 30 and enters 23 in a partially liquefied condition into the distillation column system for nitrogen-oxygen separation.

Another part 25 of the second partial air stream 7/21 is taken out of the main heat exchanger as a turbine air stream at an intermediate temperature. Its quantity relative to the internal compression air is adjusted by the vanes of the compressor. The ratio of the volume streams from the first partial stream 6 and the second partial stream 7/21 is adjusted by an expansion valve 30 in partial stream 22.

The turbine air 25 is expanded in an expansion turbine 26 to about the operating pressure of the high-pressure column. The expanded turbine air 27 is taken along with the first partial stream 10 via line 11 into the high-pressure column of the distillation column system for nitrogen-oxygen separation. The turbine 26 in the embodiment represents a fundamental element of the refrigeration system of the installation.

In what follows, the open and closed loop controls 34 of the embodiment will be described.

The current volumes of the first partial air stream 6 upstream from the indirect heat exchange 9 and of the product stream 16 downstream from the indirect heat exchange 9 are measured by two measuring devices FI2 and FI3. (A difference from the corresponding measured values for the streams 5 and 21 can take the place of directly measuring the volume of the partial air stream 6.) The measured values are transmitted to a first arithmetic logic unit 32 which performs a balance calculation and calculates a target value for the quantity of the second partial air stream 7/21. The measured values for additional streams which are involved in the indirect heat exchange 9 can go into the balance calculation but not the volume of the second partial air stream 7/21 whose target value is being calculated.

On the one hand, the target value is passed on to a second arithmetic logic unit 31 into which, in addition, is provided the output of the temperature difference regulator TDC1. TDC1 regulates the differences of the temperatures of the streams 16 and 21 measured at the warm end of the heat exchanger 9. With the help of the output value of TDC1, the second arithmetic logic unit 31 corrects the target value and passes it on to the volume controller for the heat carrier stream FC1 which adjusts the volume stream of the second partial air stream 7/21 to this target value.

On other hand, the target value calculated by the first arithmetic logic unit 32 is passed to a comparison unit FDI1 which compares it with the current measured value for the volume stream of the second partial air stream 7/21. The difference between target and measured value is filtered 33 for the purpose of delaying shutdown. The filtered value is an input variable for a limit value transducer FDSH1 which, if necessary, issues a signal 35 to shut the installation down.

The control and regulation functions, including the first and second arithmetic logic units 32 and 31 can of course be made up of the same hardware, for example, a microprocessor unit or a computer.

Naturally the invention can be applied to any other internal compression method, in particular to those having divergent refrigeration with one or more turbines which blow air into the high-pressure column and/or into the low-pressure column or expand a nitrogen-enriched fraction from one of the separating columns of the distillation column system 12.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for variable extraction of a pressurized product by low-temperature gas fractionation in a distillation column system, in which:
feed gas is cooled and taken to the distillation column system;
a product stream is removed from the distillation column system;
the product stream is brought to a high pressure in a liquid state;
the product stream at the high pressure is evaporated or pseudo-evaporated by indirect heat exchange with a heat carrier stream;
the heat carrier stream is at least partially condensed or pseudo-condensed in the indirect heat exchange; and
the evaporated or pseudo-evaporated product stream is removed as a pressurized product in variable quantities, wherein:
a quantity of heat transferred in the indirect heat exchange is balanced;
from this balance a target value for a volume of at least one of the streams involved in the indirect exchange of heat is calculated; and
the target value is adjusted as part of feed forward control.

2. The method according to claim 1, wherein a temperature difference of the heat carrier stream and the product stream is measured at the indirect heat exchange and a measured value for the temperature difference is taken into consideration when calculating the target value.

3. The method according to claim 1, wherein the volume of at least one of the streams involved in the indirect heat exchange is measured, a value for the volume measured is compared with the calculated target value and as a function of a difference between the measured volume and the target value shutting down the indirect heat exchange is initiated.

4. An apparatus for variable extraction of a pressurized product by low-temperature gas fractionation in a distillation column system, comprising:
means to cool feed gas and to introduce cooled feed gas into the distillation column system;
means to remove a product stream from the distillation column system;
means to increase a pressure of the product stream in a liquid state to a high pressure;
a heat exchanger for evaporation or pseudo-evaporation of the product stream at high pressure by indirect heat exchange with an at least partially condensing or pseudo-condensing heat carrier stream;
means to remove the evaporated, or pseudo-evaporated, product stream in variable quantities as a pressurized product; and
means for controlling and regulating which:
balance a quantity of heat transferred in the indirect heat exchange;
calculate from this balance a target value for a volume of at least one of the streams involved in the indirect heat exchange; and
adjust the target value as part of feed forward control.

5. A method of controlling a flow through a heat exchanger, comprising the steps of:
flowing a product stream from a distillation column system at a high pressure and in a liquid state through the heat exchanger;
flowing a heat carrier stream through the heat exchanger;
evaporating or pseudo-evaporating the product stream by indirect heat exchange in the heat exchanger by the heat carrier stream;
calculating a target value for a volume of the heat carrier stream flowing through the heat exchanger; and
adjusting the volume of the heat carrier stream flowing through the heat exchanger to the target value.

6. The method according to claim 5, further comprising the step of correcting the target value based on a temperature difference between the product stream and the heat carrier stream at a warm end of the heat exchanger.

7. The method according to claim 5, further comprising the steps of comparing the target value with a measured value for the volume of the heat carrier stream and basing a determination to shut down an operation of the heat exchanger on the comparing step.

8. The method according to claim 5, wherein the step of calculating includes the steps of measuring a value for a volume of a partial air stream flowing through the heat exchanger and measuring a value for a volume of the product stream flowing through the heat exchanger.

9. An apparatus for controlling a flow through a heat exchanger, wherein:
a product stream from a distillation column system at a high pressure and in a liquid state flows through the heat exchanger;
a heat carrier stream flows through the heat exchanger; and
the product stream is evaporated or pseudo-evaporated by indirect heat exchange in the heat exchanger by the heat carrier stream;
comprising:
a logic unit, wherein the logic unit calculates a target value for a volume of the heat carrier stream flowing through the heat exchanger; and
a volume controller coupled to the logic unit, wherein the volume controller adjusts the volume of the heat carrier stream flowing through the heat exchanger to the target value.

10. The apparatus according to claim 9, further comprising a second logic unit coupled to the logic unit, wherein the second logic unit corrects the target value based on a temperature difference between the product stream and the heat carrier stream at a warm end of the heat exchanger.

11. The apparatus according to claim 9, further comprising a comparison unit coupled to the logic unit, wherein the comparison unit compares the target value with a measured value for the volume of the heat carrier stream.

12. The apparatus according to claim 11, further comprising a limit value transducer coupled to the comparison unit, wherein the limit value transducer receives an input from the comparison unit and bases a determination to shut down an operation of the heat exchanger on the input.

13. The apparatus according to claim 9, wherein the logic unit receives a measured value for a volume of a partial air stream flowing through the heat exchanger and a measured value for a volume of the product stream flowing through the heat exchanger.
